(19) United States
(12) Patent Application Publication
(10) Pub. No.: US 2019/0059017 A1
(43) Pub. Date: Feb. 21, 2019

(54) Communications resource control by a network node

(71) Applicant: Robotonchip Oy, Espoo (FI)

(72) Inventors: Jari Rahkala, Espoo (FI); Marko Lamminaho, Espoo (FI); Erkki Savilampi, Espoo (FI)

(21) Appl. No.: 16/104,156

(22) Filed: Aug. 17, 2018

(30) Foreign Application Priority Data
Aug. 17, 2017 (FI) 20175739

(51) Int. Cl. H04W 28/02; H04L 12/863; H04L 12/911; H04L 12/26

(52) U.S. Cl. CPC H04W 28/0221; H04L 47/6255; H04W 84/18; H04L 47/745; H04L 43/0882; H04L 47/826

(57) ABSTRACT

According to an aspect of the present invention, there is provided a method, comprising: transmitting packets via a transmission buffer by a first interface duty cycle, detecting a flood control condition of the transmission buffer, including a flood control indication in one or more packets in response to detecting the flood control condition, and transmitting the one or more packets by a second interface duty cycle.

### FIELD

The present invention relates to controlling communications resources by a node of a communications network, and in particular to flood control by a node of a multi-hop network.

### BACKGROUND

Reduced quality of service is resulted when a network node is carrying more data than it can handle. Typical effects include queueing delay, packet loss or the blocking of new connections. Network protocols that use aggressive retransmissions to compensate for packet loss due to congestion can increase congestion, even after the initial load has been reduced to a level that would not normally have induced network congestion. Networks use congestion control and congestion avoidance techniques to try to avoid congestive collapse, for example exponential backoff in protocols such as the IEEE 802.11 CSMA/CA and the Ethernet and window reduction in TCP. Another method is to implement priority schemes, transmitting some packets with higher priority than others. A third avoidance method is the explicit allocation of network resources to specific flows.

Operation of network node devices is typically designed to cope with maximum/peak load. When there is no data to transmit or receive during an idle period of an active data connection, overall power consumption is naturally reduced, but the device typically still operates with the same processing intensity and the provided communications resource is just not used. There is need to provide further improvements in communications resource control particularly for communications devices for which it is essential to achieve as low power consumption as possible, such as standalone machine-to-machine M2M or Internet of Things IoT devices without external power supply.

### SUMMARY OF THE INVENTION

The invention is defined by the features of the independent claims. Some specific embodiments are defined in the dependent claims.

According to a first aspect of the present invention, there is provided a method for a transmitting node of a communications network, comprising: transmitting packets via a transmission buffer by a first interface duty cycle, detecting a flood control condition of the transmission buffer, in response to detecting the flood control condition including a flood control indication in one or more packets, said one or more packets comprising a payload field, and transmitting the one or more packets by a second interface duty cycle.

According to a second aspect of the present invention, there is provided a method for controlling communications resources by a receiving node of a communications network, comprising: receiving a packet comprising a payload field by a first interface duty cycle, detecting a flood control indication in the received packet, in response to detecting the flood control indication, receiving one or more packets by a second interface duty cycle, and in response to detecting lack of flood control indication during reception of a packet by a second interface duty cycle, adapting interface duty cycle for packet reception.

According to a third aspect of the present invention, an apparatus comprising at least one processing core, at least one memory including computer program code, the at least one memory and the computer program code being configured to, with the at least one processing core, cause the apparatus at least to perform a method according to the first aspect and/or the second aspect.

According to a fourth aspect of the present invention, there is provided a computer program configured to cause a method in accordance with at least one aspect to be performed.

According to a fifth aspect of the present invention, there is provided a non-transistory computer readable medium having stored thereon a set of computer readable instructions that, when executed by at least one processor, cause a network node to at least perform a method according to the first aspect and/or the second aspect.

### BRIEF DESCRIPTION OF THE DRAWINGS

FIGS. 1 and 2 illustrate methods in accordance with at least some embodiments of the present invention;

FIG. 3 illustrates a packet format in accordance with at least some embodiments of the present invention;

FIG. 4 illustrates communications resource control modes in accordance with at least some embodiments of the present invention;

FIG. 5 illustrates an apparatus in accordance with at least some embodiments of the present invention; and

FIGS. 6 to 9 illustrate example traffic scenarios in accordance with at least some embodiments of the present invention.

### EMBODIMENTS

Dynamic resource adaptation is now provided for transmitting and receiving devices, facilitating very low power consumption during idle or low-activity periods and instant increase of resources during flooding transmission conditions. Packets are first transferred by a first interface duty cycle. Upon detecting a flood control condition of a transmission buffer, a second interface duty cycle is entered and a flood control indication is included in one or more packets.

A flood or flooding herein refers generally to a situation where a large number of packets is to be or being transferred, causing a high load on the transmitter or receiver. The instant increase of packets to be transferred may have already caused or will likely cause the transmission or reception buffer to become full or overflow. For example, such situation may be caused by a multi-hop flooding transmission, without restricting to any particular transfer method. Thus, a specific resource increase procedure involving the changed interface duty cycle may be initiated to instantly meet the flood condition. The flood control condition refers to a predefined trigger causing the resource increase procedure and is detected by the network node on the basis of one or more threshold values. The flood control condition may be detected on the basis of fast increase of packets in a transmission buffer or a predetermined occupancy level of the transmission buffer being reached or exceeded.

The interface duty cycle herein refers to an operation period of a communications interface, comprising a transmission or reception event or activity and an idle period for power-saving, the proportion of which may differ. For example, during a normal or low-activity operation mode 100 millisecond duty cycle comprising one active transmission or reception event of around one ms and an idle period of 99 ms is applied. During a flooding condition the duty cycle may be substantially reduced, for example to 1 ms. The interface duty cycle may be alternatively defined as percentage or ratio of active transmission or reception event time of the total operation period (e.g. 20% duty cycle may refer to using 20% the operation period for transmission.

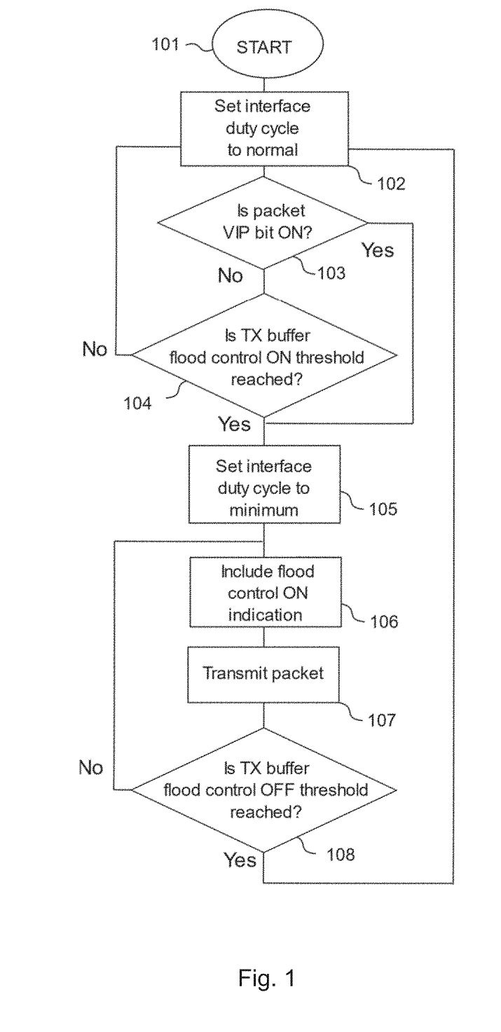

FIG. 1 illustrates a method for transmitting packets in accordance with at least some embodiments of the present invention. The method provides flood control and may be carried out in a network node capable of at least transmitting packets, such as a wireless mesh network node. The process may start 101 upon activating a transmission interface for transmission and/or when there is a need to transmit a packet via the communications interface of a network node. Phase 102 comprises setting the interface duty cycle to the first value, which may be a default setting, applied in normal operation condition and referred to as “normal interface duty cycle”, such as 100 ms.

A flood control operation or mode triggered by the detection of the flood control condition may be initiated also on the basis of another trigger than the state of the transmission buffer. In some embodiments the packet to be transmitted may comprise, or an upper protocol layer may otherwise indicate, a high rate indication for increasing the data transmission capacity. For example, such high rate indication may be provided by an ON/OFF high rate bit in the packet format. Thus, the method may involve checking if a packet to be transmitted comprises or is otherwise associated with a high rate indication, e.g. by checking if the high rate bit is set ON. In response to the packet comprising the high rate indication, the packet may be transmitted with the flood control indication with the second interface duty cycle.

The high bit rate indication, in an embodiment illustrated in FIG. 1 a VIP bit, enables to decrease the duty cycle to ensure that a packet with such indication, in an embodiment a VIP packet, and also other packets pending transmission are transferred with increased intensity. The VIP packets may be further prioritized over other packets in a transmission queue by a QoS mechanism, which may also utilize the high bit rate indication or the VIP bit. Hence, the duty cycle change facilitates to avoid delaying of non-prioritized packets due to prioritized packets, and to provide operative prioritized data transmission also in very heavily loaded network.

However, it is to be appreciated that the method of FIG. 1 may be applied without the high bit rate or VIP bit check 103, or another further trigger causing the flood control.

Phase 104 comprises checking the state of the transmission buffer, for detecting the flood control condition and triggering the flood control on the basis of the state of the buffer. The flood control condition may be detected in response to the amount of packets in the transmission buffer reaching a flood control condition threshold value, which may also be referred to as a flood control on threshold.

Phase 105 comprises setting the interface duty cycle to the second value applied for transmission of packet during the flood control condition. For example, minimum duty cycle of the available duty cycle values may be applied during the flood condition. However, it will be appreciated that the cited normal and minimum interface work cycles represent non-limiting examples and various other values within available work cycle values may be selected in steps 102 and 105. In some embodiments, the value in step 102 and/or 105 may be selected on the basis of further historical data processing or big data analysis. For example, time/date may affect the value selection based on historical resource usage information such that the work cycle value is during Mondays 9-12 am set smaller than 1-5 am. This further facilitates power saving at network nodes.

Phase 106 comprises including the flood control indication in the packet to be transmitted. The indication may be included in a packet next to be transmitted amongst the packets in the transmission buffer. In some embodiments the flood control condition and the lack of flood control condition are indicated by a state of a packet flood control bit. Phase 107 comprises transmitting the packet.

The transmission buffer is monitored during the flood control condition for determining if the flood control needs to be continued. In response to detecting termination of the flood control condition on the basis of the state of the transmission buffer, at least one packet is transmitted by the first interface duty cycle and without the flood control indication. The termination of the flood control condition may be detected based on the amount of packets in the transmission buffer falling under a flood control condition termination value.

Flood control, and data cycle and flood control indication, may thus be set for each packet in the transmission buffer. If the state of the buffer does not cause flood control condition, the high rate bit indication in a packet may still cause setting the flood control indication to the packet and transmitting the packet by the second interface duty cycle. After transmission of such packet, need for flood control indication and transmission by the second interface dutycycle may be determined separately for a subsequent packet in the transmission buffer.

With reference to the example of FIG. 1, phase 108 comprises checking if the transmission buffer flood control OFF threshold is reached. If yes, the normal interface duty cycle is reinstated 102. If no, the flood control condition (and mode) continues and the flood control indication is included 106 in the subsequent packet.

In some embodiments the termination of the flood control condition may be detected or based on removal of the other trigger (than the state of the transmission buffer). The removal of such flood condition may be detected on the basis of a subsequent packet not including the high rate indication, for example if the VIP bit is OFF.

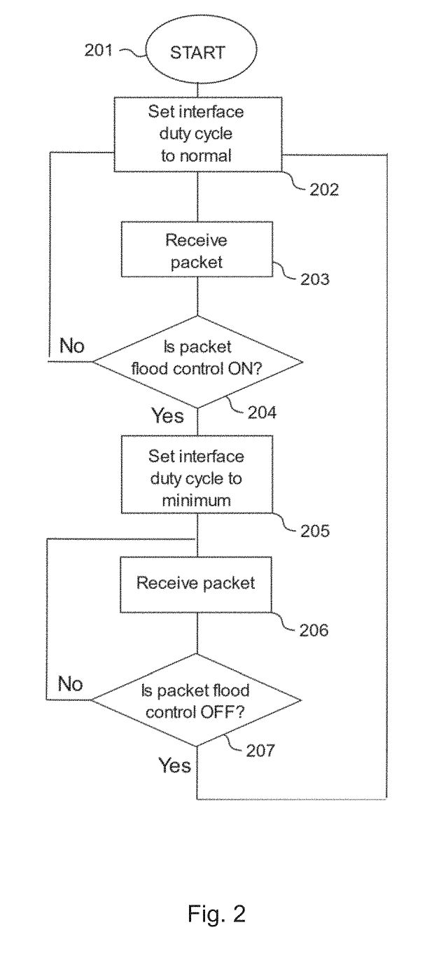

FIG. 2 illustrates a method for receiving packets in accordance with at least some embodiments of the present invention. The method provides flood control and may be carried out in a network node capable of at least receiving packets, such as a wireless mesh network node. The process may start 201 upon activating a transmission interface for transmission and/or a need to transmit a packet via the communications interface of a network node. Phase 202 comprises setting the interface duty cycle to the first duty cycle value, which may be the normal interface duty cycle value.

Phase 203 comprises receiving a packet by the first interface duty cycle. Phase 204 comprises checking for a flood control indication in the received packet, in some embodiments based on the state of the flood control bit in the received packet. In response to detecting the flood control indication in the received packet (flood control ON), the interface duty cycle is set, in step 205, to a second value facilitating increase in reception activity as signaled by the transmitter, in some embodiments to the minimum value.

Step 206 comprises receiving at least one packet (after the packet that caused entering the step 205) by the second interface duty cycle. Step 207 comprises checking if the received packet comprises the flood control indication. In some embodiments this is detected by checking the state of the flood control bit: ON or 1 referring to flood control indication and OFF or 0 to lack of flood control indication. In response to detecting the flood control indication, reception 206 for next packet is continued with the second interface duty cycle. In response to detecting lack of flood control indication, interface duty cycle for packet reception is adapted. In some embodiments the interface duty cycle is changed back 202 to the first interface duty cycle value, such as the normal interface duty cycle.

It will be appreciated that there may be some other value (than the first interface duty cycle value) applied after termination of the flood control condition and/or detection of lack of flood control indication, e.g. to enable gradual recovery from the flood control condition and duty cycle change after the termination of the flood control condition. Multiple receiving nodes for a packet comprising a flood control indication, and the nodes may apply the above illustrated features for flood control.

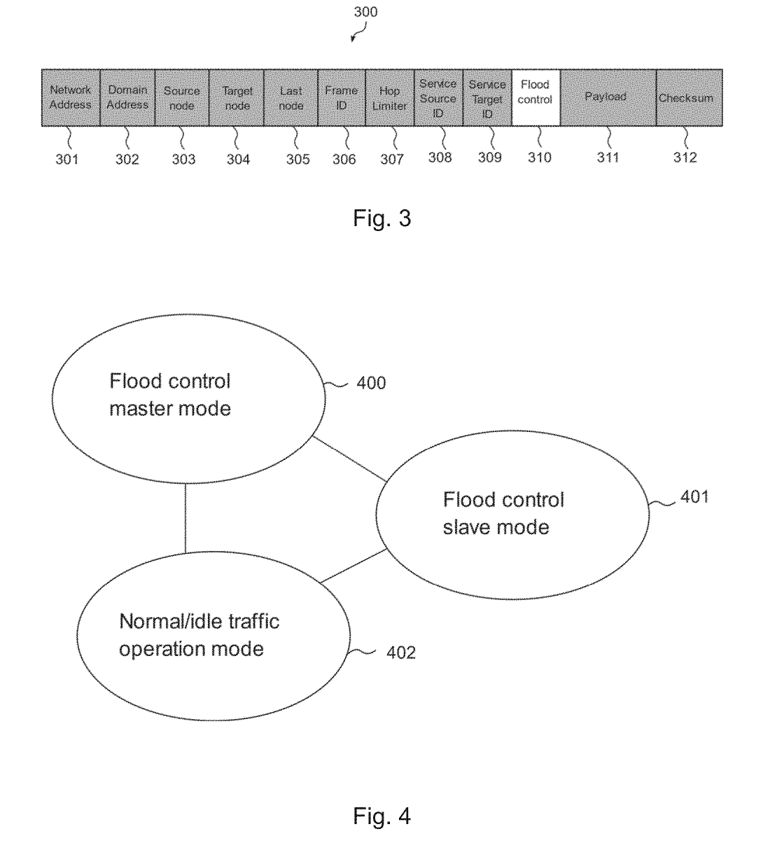

FIG. 3 illustrates a format or a packet 300 that may be used in connection with at least some embodiments. The packet may be a digital data transmission unit or media frame suitable for computer networking and telecommunication. The packet may comprise at least some of the following fields: a network address 301, a domain address 302, a source node identifier 303, a target node identifier 304, a last node identifier 305, a frame identifier 306, a hop limiter 307, a service source identifier 308, a service target identifier 309, flood control field or bit 310, payload 311 and checksum 312.

The domain address 302, source node identifier 303, target node identifier 304 and last node identifier 305 may indicate identifiers of the nodes. The identifiers may be unique in the network and used for addressing nodes within the network. The domain address may serve for identifying a domain of the network, whereby the identifiers may be unique within the domain. Formats of the identifiers and the domain address may be human-readable but also machine-readable data formats, for example Internet Protocol addresses or Medium Access Control (MAC) addresses are feasible. Identifiers of human-readable formats may be naturally read by humans, for example text in a selected character set for example ASCII character set. For example, the text may represent people names. The identifiers may be defined by user according to a desired logic. It should be appreciated that only a specific user may be authorized to manage node identifiers. The user authorized to manage node identifiers may be an administrator of the node and/or administrator of the network. The checksum 312 may serve for detecting errors in the packet.

The service source identifier 308 may serve for identifying a source application (App) and a service target identifier 309 may serve for identifying a target application. The payload 311 may serve for carrying data from a source node to a target node.

In some embodiments the network nodes are multi-hop and/or mesh network nodes and the packet comprises fields 305 and 307. The hop limiter 307 may serve for indicating a maximum time to live (TTL) of the packet. The TTL may be indicated by a number of hops. A connection between nodes of the mesh network may determine a single hop, whereby a transmission of the frame over a connection between nodes in the mesh network may cause an update of the hop limiter. Initially the hop limiter may be set to a maximum number of hops, whereby a hop may reduce the value of the hop limiter. The network address 301 may serve for indicating different mesh networks from each other. Packets cannot pass through different networks than the network address indicates.

The packet 300 may be processed by more than one protocols. The protocols may comprise a link layer protocol, a network layer protocol, a service layer protocol for example. Accordingly, at least some of the fields may be adapted to be processed by more than one protocol. A protocol stack may comprise protocols on a plurality of layers of the protocol stack for processing the packet.

The packet encapsulates data in the payload 311 to be transmitted on a physical layer. Preferably the packet is not limited to a digital data transmission unit of a single protocol or a protocols layer. Indeed the packet may serve for a digital data transmission unit of a plurality of protocols that are on different layers. Accordingly, the fields of the packet may be utilized by more than one protocol on different protocol layers. In one example, the source node identifier may be utilized on both link layer and a network layer.

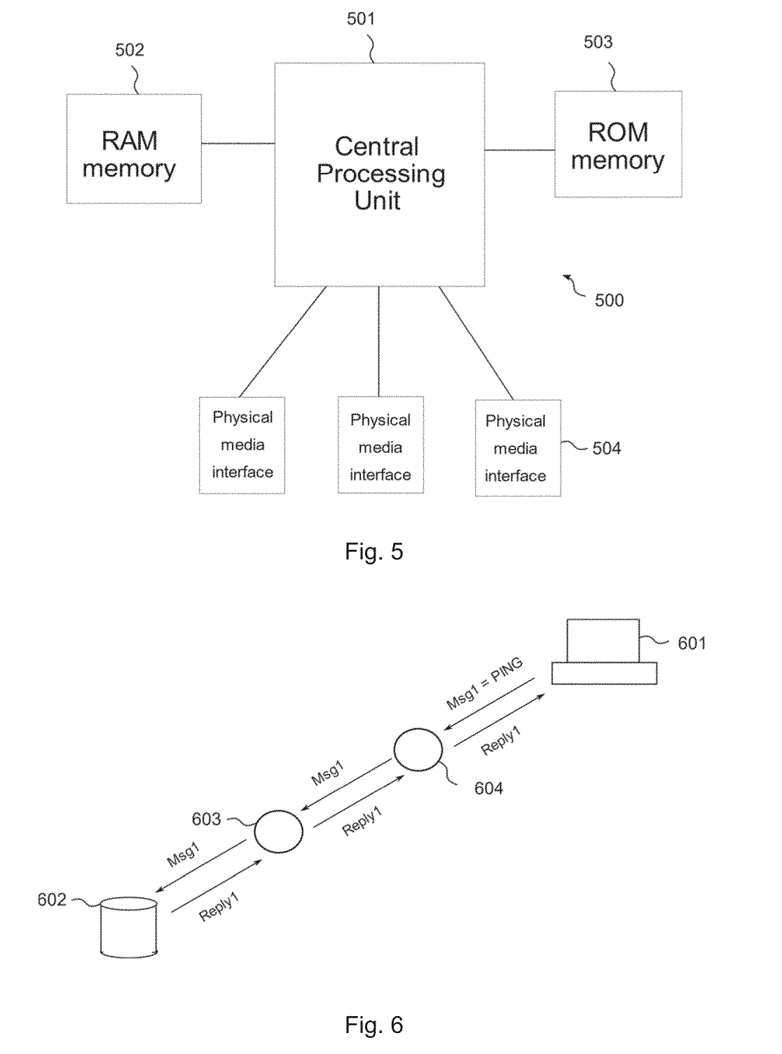

At least some of the presently disclosed embodiments may be applied in a mesh network, such as a mesh network illustrated in patent application no. FI20175492. In the mesh network, a node that forwards a packet may change a last node identifier of the packet. It should be appreciated that payload of the packet may be unchanged in the forwarding. One or more nodes, even all nodes, other than the source node may update routing information to a route ring buffer, for example as described in FIG. 5 of FI20175492. A reverse route may be determined for a received media frame. The received media frame may be prevented from being forwarded in the mesh network when the route ring buffer comprises routing information corresponding to the reverse route. In this way the route ring buffer may be updated in selected nodes of the mesh network and traffic load caused by forwarding of the media frames may be controlled.

In an example procedure according to at least some embodiments, packets may be processed at the nodes by a protocol stack comprising the following layers in a top down order: application, service, network, link and physical. The packets may have the format described with FIG. 3. The link layer may be caused to execute one or more functionalities described with the methods of FIGS. 1 and 2. A packet may be caused by an application which provides to a service layer as input target node identifier, service source identification, target node identifier and payload data. Then, a service layer may create the packet with input from application and adds source node identifier 303, network address 301, domain address 302, unique message identifier and time-to-live (TTL) information 307. The created packet is forwarded to network layer's transmit function. Next, the network layer may add the node's own identifier as last node identifier of packet. If TTL has lapsed, the packet may be deleted or ignored. Otherwise, the TTL may be reduced and the packet may be forwarded to the link layer. In the link layer, the flood control information 310 may be added to the packet.

FIG. 4 illustrates communications resource control modes in accordance with at least some embodiments of the present invention. A flood control master mode 400 may be entered in response to detecting the flood control condition. A flood control slave mode 401 may be entered in response to detecting the flood control indication. A normal (or idle) operation mode 402 refers to an operation mode in which the flood control is OFF. The mode 402 may be entered as a default mode (102), in response to detecting the lack of the flood control indication, or the termination of the flood condition, as illustrated in FIGS. 1 and 2.

An electronic device comprising electronic circuitries may be an apparatus for realizing at least some embodiments of the present invention and capable of carrying out at least some of the features illustrated above. The apparatus may be or may be comprised in a computer, a laptop, a tablet computer, a cellular phone, a machine to machine (M2M) device (e.g. a sensor device), a wearable device, or any other apparatus provided with radio communication capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

FIG. 5 illustrates an apparatus 500 in accordance with at least some embodiments of the present invention. The apparatus may be a node in a network, in some embodiments a mesh network, and caused to perform one or more functionalities according an embodiment. A node may be attached to the network, and capable of creating packets to be transmitted over a communications channel, receiving, or transmitting packets on a communications channel. The apparatus may be arranged to carry out at least some of the embodiments related to flood control in transmitting and/or receiving packets illustrated above. The device may include one or more controllers configured to carry out operations in accordance with at least some of the embodiments illustrated above, such as some or more of the features illustrated in connection with FIGS. 1 to 4.

The apparatus 500 may comprise a processor 501 and a memory 502, 503, and one or more communication interfaces 504. The processor may comprise one or more processing cores. The processor may comprise at least one application-specific integrated circuit, ASIC. The processor may comprise at least one field-programmable gate array, FPGA. The processor may be means for performing method steps in the device.

The memory may comprise random-access memory and/or permanent memory. The memory may comprise at least one RAM chip. The memory may comprise solid-state, magnetic, optical and/or holographic memory, for example. The memory may be at least in part accessible to the processor 501. The memory may be at least in part comprised in the processor 501. The memory may store a computer program comprising computer instructions that the processor is configured to execute, to cause one or more functionalities described in the embodiments. The processor and the memory may be operatively connected to the processor for communications of data for execution of the computer program by the processor. The connection between the processor and the memory may be a data bus for example. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 600 but accessible to the device. Control parameters affecting operations in the device may be stored in one or more portions of the memory and used to control operation of the device.

The communications interfaces may provide a communications channel for communications of packets in the network. Examples of the communications interfaces comprise network interface cards and network interface modules that may be connected to the apparatus by means of wired or wireless connections. Wireless connections may comprise Bluetooth and IEEE 802.11 based Wireless Local Area Network (WLAN) connections, for example. The wired connections may comprise data buses, for example. The processor 501 may be operated to control at least some of the communications interfaces 504 by applying at least some of embodiments associated with flood control and illustrated above in connection with FIGS. 1 to 4.

Reference is made to example scenarios of FIGS. 6 to 9. First, there is light traffic between the nodes 601 to 604 and the nodes may operate in the normal operation mode 402. In the first stage illustrated in FIG. 6, the source node 601 may carry out a service availability check by transmitting a ping message Msg1. The ping message is transferred to the destination node 602 hosting a service, and a response message Reply1 is transferred to the source node 601.

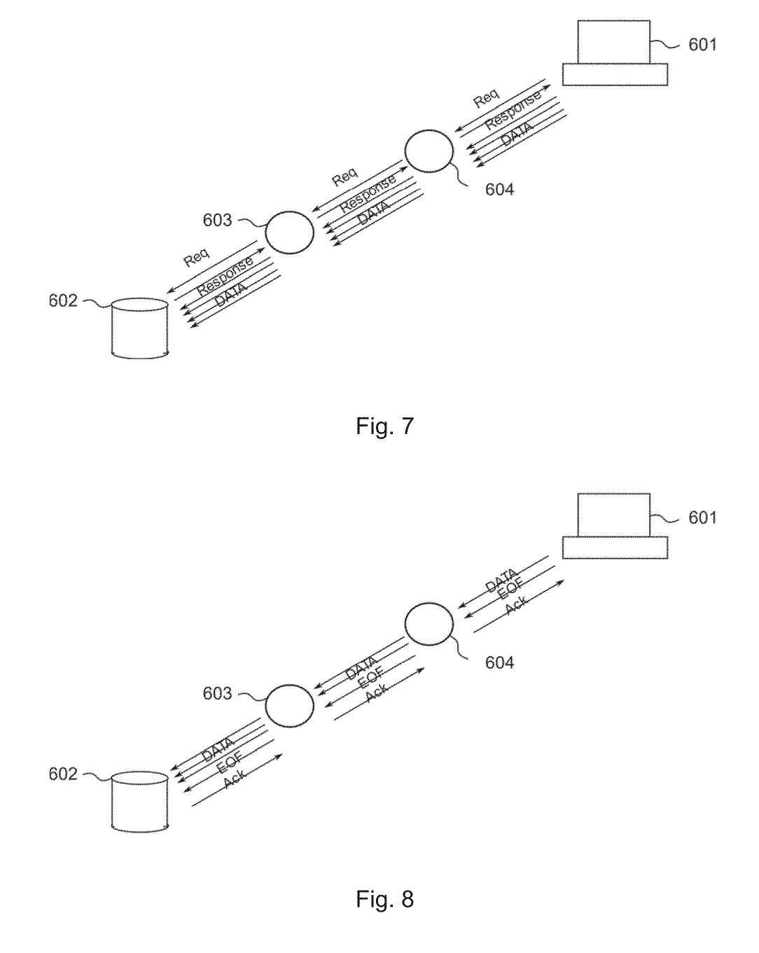

Next, as illustrated in FIG. 7, the source node 601 may start data transmission after receiving a response to data transmission request message Req. A large number of packets need to be transmitted and the transmission buffer of the source node reaches the level triggering the flood control condition. Then, the source node 601 enters the flood control master mode 400, changes 105 the interface duty cycle and includes flood control indication in the subsequent packet(s). Upon detecting the flood indication in the received packet, the receiving node 604 changes its interface duty cycle. As a transmitting node, node 604 further changes to the flood control master mode 400 towards the next receiving node 603. The next node 603 operates similarly as the node 604, and the destination node 602 also reacts to the flood control indication as a receiving node.

In FIG. 8, the amount of packets to be transmitted reduces, e.g. an end of file (EOF) may be reached. This causes stabilization of the situation and termination of the data flood condition. Thus, the nodes 601, 604 and 603 may enter step 102 as transmitting nodes and the nodes 604, 603 and 602 may enter step 202 as receiving nodes. Hence, the network returns to the normal operation mode enabling substantially reduced or minimal resource usage and energy consumption, which may be optimized for base or default traffic of the network.

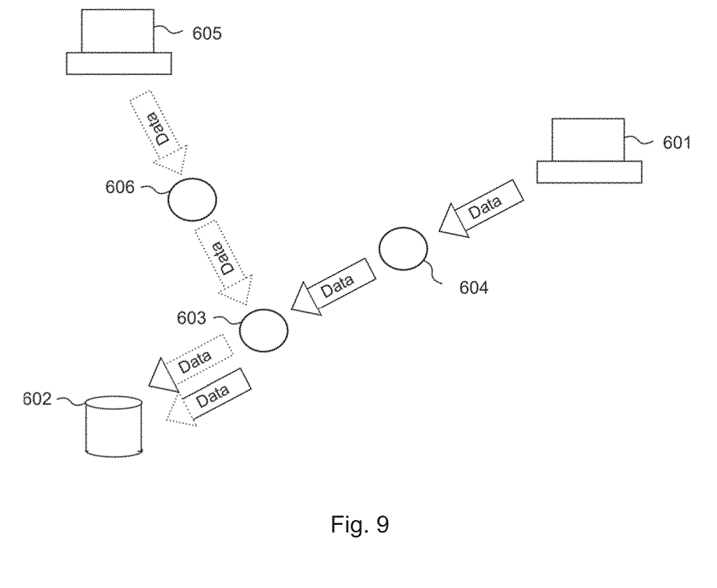

FIG. 9 further illustrates a scenario where a node 603 receives data from two or more transmitting nodes 604 and 606 and may enter 105 the flood control master mode due to the increased amount of received packets.

In an embodiment, a receiving node may in some specific conditions be arranged to enter flood condition by another trigger than the flood control indication, even if a received packet does not include the flood control indication. For example, the flood control (slave) mode may be controlled by a network control function or during a reboot situation to monitor frequency channel usage thoroughly. The trigger may be set e.g. during predefined time period and/or at predefined position/area, the receiving node may be configured to receive data at the second interface duty cycle to ensure high reception capacity e.g. to ensure time-critical data transmission delivery e.g. for healthcare service. The trigger may be set for commercial reasons, such as prearrange adequate reception capacity for local advertisements.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though a member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. A method for controlling communications resources by a transmitting node of a communications network, the method comprising:
transmitting packets via a transmission buffer by a first interface duty cycle,
detecting a flood control condition of the transmission buffer,
in response to detecting the flood control condition, including a flood control indication in one or more packets, said one or more packets comprising a payload field, and
transmitting the one or more packets by a second interface duty cycle.

2. The method of claim 1, wherein the transmission buffer is monitored after the detection of the flood control condition, and in response to detecting termination of the flood control condition on the basis of the state of the transmission buffer, at least one packet is transmitted by the first interface duty cycle and without the flood control indication.

3. The method of claim 2, wherein the termination of the flood control condition is detected based on the amount of packets in the transmission buffer falling under a flood control condition termination value.

4. The method of claim 1, wherein the flood control condition is detected in response to the amount of packets in the transmission buffer reaching a flood control condition threshold value.

5. The method of claim 1, wherein a flood control master mode is entered in response to detecting the flood control condition.

6. The method of claim 1, further comprising checking if a packet to be transmitted comprises a high rate indication, and in response to the packet comprising the high rate indication, setting the flood control indication to the packet and transmitting the packet by the second interface duty cycle.

7. A method for controlling communications resources by a receiving node of a communications network, the method comprising:
receiving a packet comprising a payload field by a first interface duty cycle,
detecting a flood control indication in the received packet,
in response to detecting the flood control indication, receiving at least one packet by a second interface duty cycle, and
in response to detecting lack of flood control indication during reception of a packet by a second interface duty cycle, adapting interface duty cycle for packet reception.

8. The method of claim 7, wherein adapting interface duty cycle for packet reception comprises changing from the second interface duty cycle back to the first interface duty cycle.

9. The method of claim 7, wherein a flood control slave mode is entered in response to detecting the flood control indication and normal or idle operation mode is entered in response to detecting the lack of the flood control indication.

10. The method of claim 1, wherein the flood control condition and the lack of flood control condition is indicated by a state of a packet flood control bit.

11. The method of claim 1, wherein the node is a wireless mesh network node.

12. An apparatus comprising at least one processing core, at least one memory including computer program code, the at least one memory and the computer program code being configured to, with the at least one processing core, cause the apparatus at least to perform a method for controlling communications resources by a transmitting node of a communications network, the method comprising:
transmitting packets via a transmission buffer by a first interface duty cycle,
detecting a flood control condition of the transmission buffer,
in response to detecting the flood control condition, including a flood control indication in one or more packets, said one or more packets comprising a payload field, and
transmitting the one or more packets by a second interface duty cycle.

13. (canceled)

14. A non-transitory computer readable medium having stored thereon a set of computer readable instructions that, when executed by at least one processor, cause a node of a communications network to carry out a method for controlling communications resources by a transmitting node of a communications network, the method comprising:
transmitting packets via a transmission buffer by a first interface duty cycle,
detecting a flood control condition of the transmission buffer,
in response to detecting the flood control condition, including a flood control indication in one or more packets, said one or more packets comprising a payload field, and
transmitting the one or more packets by a second interface duty cycle.

15. The method of claim 7, wherein the flood control indication and the lack of flood control indication is indicated by a state of a packet flood control bit.

16. The method of claim 7, wherein the node is a wireless mesh network node.

17. An apparatus comprising at least one processing core, at least one memory including computer program code, the at least one memory and the computer program code being configured to, with the at least one processing core, cause the apparatus at least to perform a method for controlling communications resources by a receiving node of a communications network, the method comprising:
receiving a packet comprising a payload field by a first interface duty cycle,
detecting a flood control indication in the received packet,
in response to detecting the flood control indication, receiving at least one packet by a second interface duty cycle, and
in response to detecting lack of flood control indication during reception of a packet by a second interface duty cycle, adapting interface duty cycle for packet reception.

18. The apparatus of claim 12, wherein the transmission buffer is monitored after the detection of the flood control condition, and in response to detecting termination of the flood control condition on the basis of the state of the transmission buffer, at least one packet is transmitted by the first interface duty cycle and without the flood control indication.

19. The apparatus of claim 18, wherein the termination of the flood control condition is detected based on the amount of packets in the transmission buffer falling under a flood control condition termination value.

20. The apparatus of claim 18, wherein the flood control condition is detected in response to the amount of packets in the transmission buffer reaching a flood control condition threshold value.

21. A non-transitory computer readable medium having stored thereon a set of computer readable instructions that, when executed by at least one processor, cause a node of a communications network to carry out a method for controlling communications resources by a receiving node of a communications network, the method comprising:
receiving a packet comprising a payload field by a first interface duty cycle,
detecting a flood control indication in the received packet,
in response to detecting the flood control indication, receiving at least one packet by a second interface duty cycle, and
in response to detecting lack of flood control indication during reception of a packet by a second interface duty cycle, adapting interface duty cycle for packet reception.
